(19) United States
(12) Patent Application Publication
(10) Pub. No.: US 2024/0331111 A1
(43) Pub. Date: Oct. 3, 2024

(54) VIDEO DENOISING USING RECURRENT NEURAL NETWORK WITH GATED RECURRENT UNIT

(71) Applicant: Visionary .AI Vision Ltd., Jerusalem (IL)

(72) Inventors: Gil Pinsky, Ness Tziona (IL); Itai Ben Shalom, Mazkeret Batya (IL)

(21) Appl. No.: 18/625,535

(22) Filed: Apr. 3, 2024

Related U.S. Application Data
(60) Provisional application No. 63/493,803, filed on Apr. 3, 2023.

(51) Int. Cl. G06T 5/70; G06T 5/60

(52) U.S. Cl. CPC G06T 5/70; G06T 5/60; G06T 2207/10016; G06T 2207/20084

(57) ABSTRACT

A method of denoising a video includes: capturing a plurality of frames of the video; inputting raw data from the frames into a recurrent neural network, said recurrent neural network including a gated recurrent unit; outputting a first denoised frame from the recurrent neural network while maintaining vectors corresponding to the first denoised frame in a memory of the recurrent neural network; and, for each subsequent frame of the video, inputting raw data from the frame and the vectors from the memory into the recurrent neural network, while applying the gated recurrent unit in order to selectively remove vectors from consideration of the neural network, and outputting subsequent denoised frames from the recurrent neural network, while storing vectors from the denoised frame in the memory.

### FIELD OF THE INVENTION

The present Application relates to the field of image processing, and more specifically, but not exclusively, to systems and methods for video denoising using a recurrent neural network having a gated recurrent unit.

### BACKGROUND OF THE INVENTION

Denoising is the process of inspecting a noisy image and recovering an estimate of the underlying clean counterpart through discarding noise artifacts. Noise corruption is especially prevalent in images captured by cameras with small sensors (e.g., smartphones or laptops) or in low light.

Video denoising is a special case of image denoising which poses both unique challenges and unique opportunities. One feature of video denoising that is different from image denoising is that each frame may be considered not only on its own, but also in context of prior and subsequent frames. Thus, an algorithm for denoising frames of videos properly considers temporal information existent in neighboring frames. When denoising a given pixel or patch, the algorithm considers similar pixels or patches, both in the reference frame and in adjacent frames. This strategy takes advantage of the strong temporal redundancy in videos along motion trajectories.

However, including temporal information when denoising comes with a corresponding challenge of increase in complexity of the required calculations. To address this additional complexity, many algorithms include a motion estimation or compensation step. This additional step causes the entire algorithm to run more slowly. As a result, various attempts have been made to replace motion estimation with alternatives.

A gated recurrent unit (GRU) is a gating mechanism in recurrent neural networks (RNN). The term “recurrent neural network” refers to a neural network that contains loops, allowing information to be stored within the network. A recurrent neural network uses reasoning from a previous analysis in order to inform its analysis of upcoming events. Standard versions of RNNs suffer from a challenge known as the “vanishing gradient problem” in which the difference between different predictions becomes too small be meaningful. GRU's try to solve the vanishing gradient problem that can come with standard recurrent neural networks. GRUs include an update gate and a reset gate. The update gate controls information that flows into memory, and the reset gate controls the information that flows out of memory. The update gate and reset gate are two vectors that decide which information will get passed on to the output. These gates are trained to keep information from the past that remains relevant to the prediction and to remove information that is irrelevant to the prediction. Gated recurrent units have been used in RNNs that have been applied in various contexts, such as natural language processing and polyphonic music modeling.

### SUMMARY OF THE INVENTION

The present disclosure introduces an extremely fast and highly accurate approach for video denoising. During the denoising process, the frames of the video are input into a RNN with a GRU. The GRU enhances the computational efficiency of the RNN by directing the RNN to “forget” certain previous states of given pixels that are no longer relevant to the denoising (e.g., due to movement of objects within the video). The RNN thus determines, for each pixel, whether to consider information of prior frames when performing the denoising. The denoising is performed accurately and in real time.

According to a first aspect, a method of denoising a video includes: capturing a plurality of frames of the video; inputting raw data from the frames into a recurrent neural network, said recurrent neural network including a gated recurrent unit; outputting a first denoised frame from the recurrent neural network while maintaining vectors corresponding to the first denoised frame in a memory of the recurrent neural network; and, for each subsequent frame of the video, inputting raw data from the frame and the vectors from the memory into the recurrent neural network, while applying the gated recurrent unit in order to selectively remove vectors from consideration of the neural network, and outputting subsequent denoised frames from the recurrent neural network, while storing vectors from the denoised frame in the memory.

In another implementation according to the first aspect, the method further includes outputting the denoised frames as a video at a rate of at least 10 frames per second.

In another implementation according to the first aspect, the recurrent neural network considers both spatial patterns in the frames and temporal continuity between adjacent frames.

In another implementation according to the first aspect, the method includes performing the denoising as part of an image signal processing pipeline.

According to a second aspect, a system for denoising a video is disclosed. The system includes a non-transitory computer-readable medium storing instructions, that, when implemented by a processor, causes the performance of the following steps: capturing a plurality of frames of the video; inputting raw data from the frames into a recurrent neural network, said recurrent neural network including a gated recurrent unit; outputting a first denoised frame from the recurrent neural network while maintaining vectors corresponding to the first denoised frame in a memory of the recurrent neural network; and for each subsequent frame of the video, inputting raw data from the frame and the vectors from the memory into the recurrent neural network, while applying the gated recurrent unit in order to selectively remove vectors from consideration of the neural network, and outputting subsequent denoised frames from the recurrent neural network, while storing vectors from the denoised frame in the memory.

### BRIEF DESCRIPTION OF THE DRAWINGS

FIG. 1 illustrates steps in a method for video denoising, according to embodiments of the present disclosure;

FIG. 2 schematically illustrates a plurality of video frames, according to embodiments of the present disclosure;

FIG. 3 schematically illustrates inputs and outputs to a recurrent neural network, according to embodiments of the present disclosure; and

FIGS. 4A-4C illustrate side-by-side frames of a noisy video and a denoised video, according to embodiments of the present disclosure.

### DETAILED DESCRIPTION OF THE INVENTION

The present Application relates to the field of image processing, and more specifically, but not exclusively, to systems and methods for video denoising using a recurrent neural network having a gated recurrent unit.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The denoising process described herein is performed by a computing device that includes a processor and a memory. The memory is a non-transitory computer-readable medium containing computer-readable instructions, that, when executed by the processor, causes the computer to perform the steps described in the present disclosure. In particular, the memory includes a computer program product configured to receive input from the image sensor and perform the denoising algorithms as described herein. The computer program product may be stored on a physical memory of the computing device or may be stored in a cloud-based or network-based memory. The computing device may include a plurality of memories and processors configured to operate together in order to perform the calculations described herein.

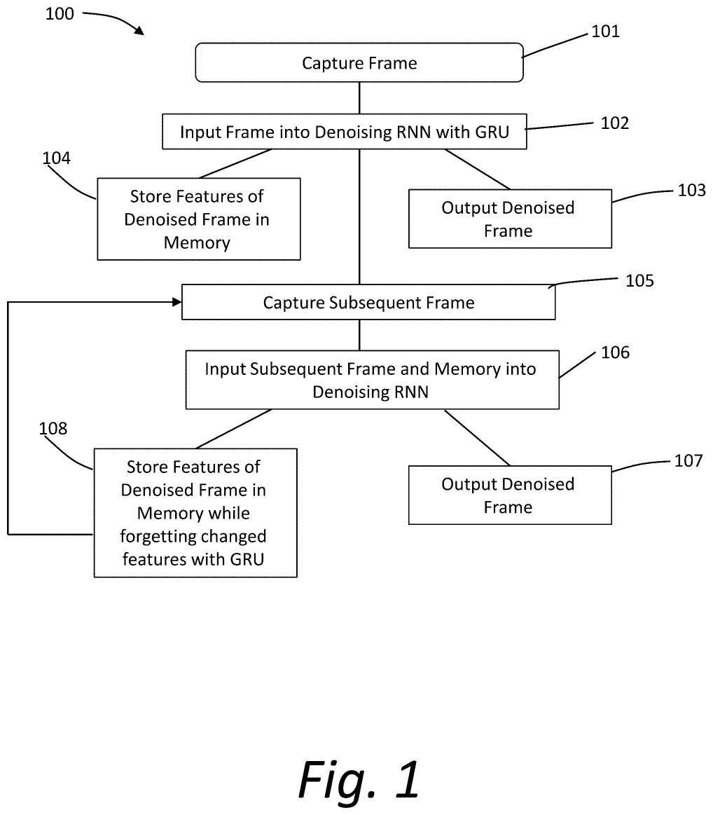

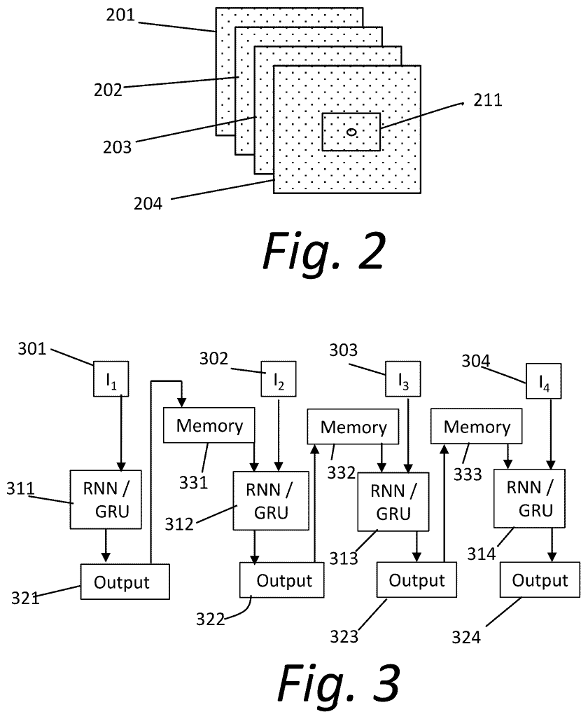

FIG. 1 depicts steps in a method of video denoising. Different aspects of this method are illustrated in FIGS. 2-4C.

Referring to FIG. 1, at step 101, an image sensor captures a frame of a video. The image sensor may be any suitable sensor, including a CMOS sensor or a CCD sensor. In one example, the image sensor is incorporated in a mobile device such as a smartphone, tablet computer, or laptop. The image sensors that are built in to such devices, especially those that are on the same side as the screen, are relatively small and thus are unable to capture high-definition images without generating a significant amount of noise. The noise that is generated may include photon shot noise, dark current noise, and readout noise.

At step 102, raw image data from the captured frame is incorporated into a recurrent neural network. The term “raw image data” refers to unprocessed or minimally processed data from the image sensors, including particularly the full dynamic range of data (12 bit or 14 bit) as read out from each of the pixels of the image sensor. The recurrent neural network is thus part of the image signal processing (ISP) pipeline.

The recurrent neural network includes a gated recurring unit. The gated recurring unit is trained to cause the recurrent neural network to “forget” certain information with respect to prior frames. For example, the gating function may determine whether certain pixels exhibit continuity with respect to the corresponding pixels in a prior frame. The GRU may contain a single gate, which either permits data through or removes the stored data. In other embodiments, the GRU may include two gates: an “update” gate and a “reset” gate. The update gate may determine an amount of the inputs provided by a prior layer to retain (e.g., include) in the memory output. The reset gate may determine an amount of the input received from the previous layer to omit (e.g., exclude) from the memory output. In other words, the update gate determines what information to “remember” and the reset gate determines what information to “forget.”

At step 103, the RNN denoises the first frame. During this denoising, the RNN considers spatial information. For example, the algorithm of the RNN may be configured to preserve contiguity of coloring of adjacent pixels, on the assumption that adjacent pixels of the same color are both signal rather than noise. At the end of the denoising, the RNN outputs a denoised frame.

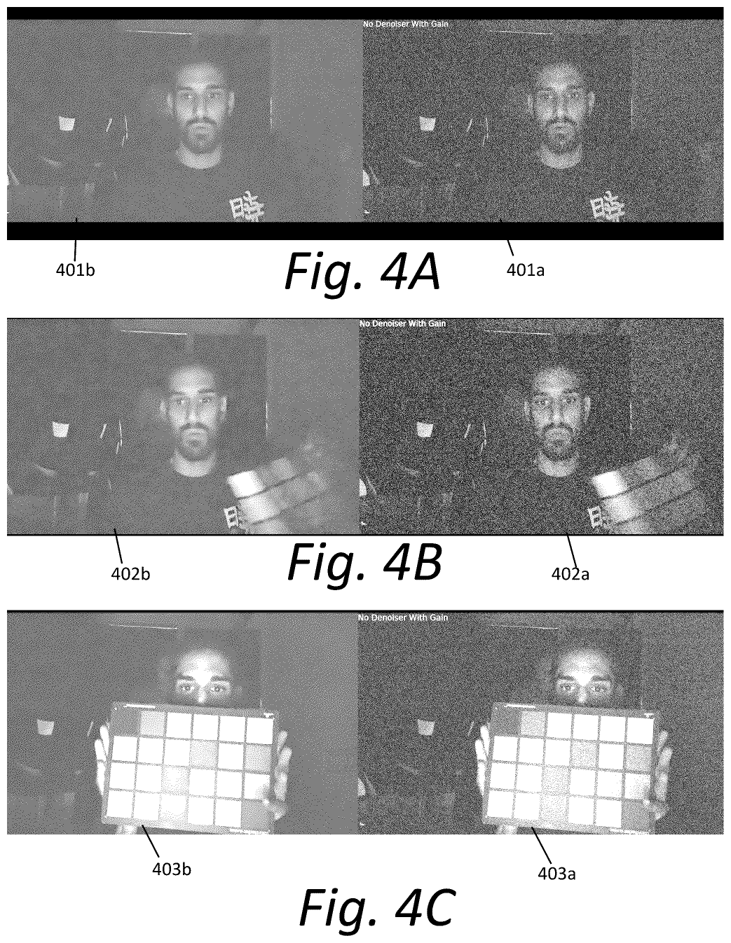

For example, with reference to FIG. 4A, image 401a is a depiction of a frame to which gain was applied (in order to make the image intelligible, as the initial video was captured in extremely low light), but no denoising was performed. Noise is present throughout the image. Image 401b is the same image to which denoising was applied.

At step 104, features of the denoised frame are stored in the memory of the RNN. The features may be stored as values in vectors. This memory is stored and available for application of the RNN to denoising of a subsequent frame.

At step 105, the image sensor captures a subsequent frame of the video. At step 106, this subsequent frame is incorporated into the RNN for denoising, along with the information stored in the memory. The denoising of the subsequent frame is performed while considering both spatial continuity, which is relevant within each frame, and temporal continuity, which is relevant between adjacent frames.

At step 107, the RNN outputs the second denoised frame. In addition, at step 108, following analysis of each frame with the GRU, the memory of the RNN is updated. The GRU selectively removes vectors from consideration of the neural network. Specifically, features that have changed from frame-to-frame are forgotten and no longer stored in the memory, while unchanged values are retained. The operation of the GRU may be on a value by value basis, for each vector.

Steps 105-108 are repeated for each subsequent frame. That is, for each subsequent frame, the RNN performs denoising, while retaining relevant information about prior frames for use in the denoising process, and discarding frames that are no longer relevant.

The RNN and GRU described herein perform denoising in real time. Real time, in this context, means achieving the denoising at a rate of at least 10 frames per second. This speed is equivalent to producing a new denoised frame every 100 milliseconds. This rate of denoising is significantly faster than any published data regarding denoising of videos, including with RNN. It is believed that the GRU, in particular, enables the highly efficient denoising process, as it stands in place of more complex methods of motion compensation.

The denoising process described herein is suitable for denoising in extreme low light settings. The specific lower limit of the lux that is suitable for capturing of the video that is denoised may depend on various additional circumstances, including the sensitivity of the image sensor. In principle, there is no intrinsic lower limit to the lux at which the video may be captured.

As is apparent from the foregoing discussion, the quality of the denoising is improved for the frames following the first frame, as compared to the first frame. This is because, for the frames following the first frame, the RNN considers both spatial and temporal information, as opposed to only spatial information. When considering a video being played back in real time, however, the minor difference in denoising quality for an initial frame or frames is barely perceptible, and is accordingly not significant.

FIGS. 2 and 3 graphically illustrate flow of operations during the denoising process. FIG. 2 shows a sequence of frames 201, 202, 203, 204 that are captured captured sequentially by an image sensor. The frames include an image 211, which is blurred due to noise.

FIG. 3 illustrates the flow of data as the RNN performs the denoising. At 301, image I₁ is input into the RNN 311. The RNN produces output 321 and also stores this output in memory 331. At 302, image I₂ is input into the RNN 312. The RNN 312 considers both image 302 and memory 331, and performs a denoising algorithm to produce output 322. The RNN further stores a memory 332, which is updated by the GRU to include only the relevant portions of the previous frames, while forgetting the portions of the previous frames that are no longer relevant (e.g. because of motion). The process continues iteratively at 303, as image I₃ is input to DNN 313, which considers the image 303 and the memory 332 in order to generate output 323. At 304, image I₄ is input to DNN 314, which considers the image 304 and the memory 333 in order to generate output 324. The process continues until the end of the video.

FIGS. 4A-4C illustrate various images generated from from a video, both in the noisy state (right side of Figures, images 401a, 402a, and 403a) and in a denoised state (left side of Figures, images 401b, 402b, and 403b). As discussed above, the denoising process described herein is performed on the raw data within the image signal processing pipeline. Thus, the images represented in FIGS. 4A-4C represent the images obtained following further processing after the denoising process, as opposed to direct results of the denoising process.

The frames are taken from approximately two seconds worth of video. In FIG. 4A, the subject is facing the camera without holding anything. In FIG. 4B, the subject is beginning to pick up a color palette, and in FIG. 4C, the subject is holding the color palette. As can be seen, in the continuity between these frames, certain pixels remain unchanged, especially in the upper and left halves of the frame, while other items change. Of course, whereas in the processed images, the changes in continuity are identifiable through pictured objects, in the raw data, the changes are identifiable through quantity of light captured by each pixel. The GRU operates to preserve the unchanged items while discarding those that have changed from the memory.

What is claimed is:

1. A method of denoising a video, comprising:
capturing a plurality of frames of the video;
inputting raw data from the frames into a recurrent neural network, said recurrent neural network including a gated recurrent unit;
outputting a first denoised frame from the recurrent neural network while maintaining vectors corresponding to the first denoised frame in a memory of the recurrent neural network; and
for each subsequent frame of the video, inputting raw data from the frame and the vectors from the memory into the recurrent neural network, while applying the gated recurrent unit in order to selectively remove vectors from consideration of the neural network, and outputting subsequent denoised frames from the recurrent neural network, while storing vectors from the denoised frame in the memory.

2. The method of claim 1, further comprising outputting the denoised frames as a video at a rate of at least 10 frames per second.

3. The method of claim 1, wherein the recurrent neural network considers both spatial patterns in the frames and temporal continuity between adjacent frames.

4. The method of claim 1, further comprising performing the denoising as part of an image signal processing pipeline.

5. A system for denoising a video, comprising a non-transitory computer-readable medium storing instructions, that, when implemented by a processor, causes the performance of the following steps:
capturing a plurality of frames of the video;
inputting raw data from the frames into a recurrent neural network, said recurrent neural network including a gated recurrent unit;
outputting a first denoised frame from the recurrent neural network while maintaining vectors corresponding to the first denoised frame in a memory of the recurrent neural network; and
for each subsequent frame of the video, inputting raw data from the frame and the vectors from the memory into the recurrent neural network, while applying the gated recurrent unit in order to selectively remove vectors from consideration of the neural network, and outputting subsequent denoised frames from the recurrent neural network, while storing vectors from the denoised frame in the memory.
